(19) United States
(12) Patent Application Publication
(10) Pub. No.: US 2013/0223305 A1
(43) Pub. Date: Aug. 29, 2013

(54) METHOD, APPARATUS, AND COMPUTER PROGRAM PRODUCT FOR POWER SAVING IN WIRELESS COMMUNICATION

(71) Applicants: Klaus DOPPLER, Albany, CA (US); Zhong-Yi JIN, Albany, CA (US); Taejoon KIM, Berkeley, CA (US); Chittabrata GHOSH, Union City, CA (US)

(72) Inventors: Klaus DOPPLER, Albany, CA (US); Zhong-Yi JIN, Albany, CA (US); Taejoon KIM, Berkeley, CA (US); Chittabrata GHOSH, Union City, CA (US)

(73) Assignee: Nokia Corporation, Espoo (FI)

(21) Appl. No.: 13/403,057

(22) Filed: Feb. 23, 2012

(51) Int. Cl. H04W 52/02

(52) U.S. Cl. 370/311

(57) ABSTRACT

Method, apparatus, and computer program product embodiments are. An example embodiment comprises: transmitting by a first wireless device to a second wireless device, a first message indicating an awake state with availability to receive wireless messages from the second wireless device; receiving by the first wireless device, an acknowledgement message from the second wireless device, including control information indicating a duration until a service period starts; and resuming a non-awake state by the first device when the control information indicates the duration satisfies a transition criterion.

### FIELD

The field of technology relates to wireless communication and more particularly to power saving in network environments.

### BACKGROUND

Modern society has adopted, and is becoming reliant upon, wireless communication devices for various purposes, such as connecting users of the wireless communication devices with other users. Wireless communication devices can vary from battery powered handheld devices to stationary household and/or commercial devices utilizing an electrical network as a power source. Due to rapid development of the wireless communication devices, a number of areas capable of enabling entirely new types of communication applications have emerged.

Cellular networks facilitate communication over large geographic areas. These network technologies have commonly been divided by generations, starting in the late 1970s to early 1980s with first generation (1G) analog cellular telephones that provided baseline voice communications, to modern digital cellular telephones. GSM is an example of a widely employed 2G digital cellular network communicating in the 900 MHZ/1.8 GHZ bands in Europe and at 850 MHz and 1.9 GHZ in the United States. While long-range communication networks, like GSM, are a well-accepted means for transmitting and receiving data, due to cost, traffic and legislative concerns, these networks may not be appropriate for all data applications.

Short-range communication technologies provide communication solutions that avoid some of the problems seen in large cellular networks. Bluetooth™ is an example of a short-range wireless technology quickly gaining acceptance in the marketplace. In addition to Bluetooth™ other popular short-range communication technologies include Bluetooth™ Low Energy, IEEE 802.11 wireless local area network (WLAN), Wireless USB (WUSB), Ultra Wide-band (UWB), ZigBee (IEEE 802.15.4, IEEE 802.15.4a), and ultra high frequency radio frequency identification (UHF RFID) technologies. All of these wireless communication technologies have features and advantages that make them appropriate for various applications.

### SUMMARY

Method, apparatus, and computer program product embodiments are disclosed for power saving in network environments.

An example embodiment of the invention includes a method comprising:

transmitting by a first wireless device to a second wireless device, a first message indicating an awake state with availability to receive wireless messages from the second wireless device;

receiving by the first wireless device, an acknowledgement message from the second wireless device, including control information indicating a duration until a service period starts; and

resuming a non-awake state by the first device when the control information indicates the duration satisfies a transition criterion.

The example embodiment of the invention further includes the method comprising:

resuming the awake state by the first device when the duration has expired.

The example embodiment of the invention further includes the method comprising:

remaining in the awake state by the first device when the control information indicates the duration is less than a first value, indicating that the service period is starting

The example embodiment of the invention further includes the method comprising:

remaining in the awake state by the first device when the control information indicates that there is data buffered for the first device in the second device,

The example embodiment of the invention further includes the method comprising the control information indicating that there are no buffered data packets for the first wireless device, in the second wireless device, when an estimated duration for the second wireless device to send data to the first wireless device is greater than a duration value due to network overload.

The example embodiment of the invention further includes the method comprising:

wherein the first message is a power save poll packet indicating an awake state with availability to receive wireless messages from the second wireless device

The example embodiment of the invention further includes the method comprising:

wherein the first wireless device is a sensor device and the second wireless device is an access point device, both devices operating using IEEE 802.11ah communications protocol.

The example embodiment of the invention further includes the method comprising:

wherein the control information in the acknowledgement message is in a field used for more-data, the control information indicating either traffic is buffered and a service period starts or indicating no traffic is buffered and the first wireless device may resume the non-awake state.

The example embodiment of the invention further includes the method comprising:

wherein the control information in the acknowledgement message includes the duration expressed in at least one of units of time, multiples of beacon durations, or multiples of short beacon durations or fractions of beacon durations.

The example embodiment of the invention further includes the method comprising:

wherein the control information in the acknowledgement message includes an estimate of a duration of data transmission by the second wireless device, that needs to be transmitted to the first wireless device before data buffered in the first wireless device may be transmitted to the second wireless device.

Example embodiments of the invention may include a computer readable medium storing program instructions, which when executed by a computer processor, perform the steps of the above recited methods.

Example embodiments of the invention may include an apparatus, comprising:

at least one processor;

at least one memory including computer program code;

the at least one memory and the computer program code configured to, with the at least one processor, cause the apparatus at least to:

transmit to a second wireless device, a first message indicating an awake state with availability to receive wireless messages from the second wireless device;

receive an acknowledgement message from the second wireless device, including control information indicating a duration until a service period starts; and

resume a non-awake state when the control information indicates the duration satisfies a transition criterion.

Example embodiments of the invention may include a method, comprising:

receiving by a second wireless device, a first message from a first wireless device, indicating an awake state of the first wireless device with availability to receive wireless messages from the second wireless device; and

transmitting by the second wireless device, an acknowledgement message to the first wireless device, including control information indicating a duration until a service period starts.

The example embodiment of the invention further includes the method comprising:

wherein the control information indicates that there is data buffered for the first device in the second wireless device.

The example embodiment of the invention further includes the method comprising:

indicating by the second wireless device in the control information, that there are no buffered data packets for the first wireless device, in the second wireless device, when an estimated duration for the second wireless device to send data to the first wireless device is greater than a duration value due to network overload.

The example embodiment of the invention further includes the method comprising:

estimating by the second wireless device a duration for the second wireless device to send data to the first wireless device is greater than a duration value, due to network overload; and

transmitting by the second device to the first device, the acknowledgement message indicating that there are no buffered data packets for the first wireless device buffered in the second wireless device.

The example embodiment of the invention further includes the method comprising:

wherein the first wireless device is a sensor device and the second wireless device is an access point device, both devices operating using IEEE 802.11ah communications protocol.

The example embodiment of the invention further includes the method comprising:

creating by the second wireless device the control information in the acknowledgement message in a field for more-data, the control information indicating either traffic is buffered and a service period starts or indicating no traffic is buffered and the first wireless device may resume the non-awake state.

The example embodiment of the invention further includes the method comprising:

estimating a duration of data transmission by the second wireless device, that needs to be transmitted to the first wireless device before data buffered in the first wireless device may be transmitted to the second wireless device; and

transmitting the estimated duration in the control information in the acknowledgement message.

Example embodiments of the invention may include a computer readable medium storing program instructions, which when executed by a computer processor, perform the steps of the above recited methods.

Example embodiments of the invention may include an apparatus, comprising:

at least one processor;

at least one memory including computer program code;

the at least one memory and the computer program code configured to, with the at least one processor, cause the apparatus at least to:

receive by a second wireless device, a first message from a first wireless device, indicating an awake state of the first wireless device with availability to receive wireless messages from the second wireless device; and

transmit by the second wireless device, an acknowledgement message to the first wireless device, including control information indicating a duration until a service period starts.

The resulting embodiments for power saving in network environments.

### DESCRIPTION OF THE FIGURES

FIG. 1A is an example network diagram of a wireless network, with a WLAN client device sending a power save poll packet to a WLAN access point device, according to an example embodiment of the invention.

FIG. 1B shows the example network diagram of FIG. 1A, wherein the WLAN access point device transmits an acknowledgement packet to the WLAN client device, with control information including a value for a duration until the next service period starts, according to an example embodiment of the invention.

FIG. 1C shows the example network diagram of FIG. 1A, wherein the acknowledgement packet sent to the WLAN client device, includes a value for a short duration until the next service period starts and the WLAN client device responds by staying awake, according to an example embodiment of the invention.

FIG. 1D shows the example network diagram of FIG. 1A, wherein the acknowledgement packet sent to the WLAN client device, includes a value for a long duration until the next service period starts and the WLAN client device responds by going back to sleep for the indicated duration until the service period starts, according to an example embodiment of the invention.

FIG. 2A is an example functional block diagram, illustrating an example WLAN client device, according to an example embodiment of the invention.

FIG. 2B is an example flow diagram of operational steps in the WLAN client device of FIG. 2A, wherein the WLAN client device transmits to WLAN access point device, a first message indicating an awake state with availability to receive wireless messages from the WLAN access point device; the WLAN client device receives an acknowledgement message from the WLAN access point device, including control information indicating a duration until a service period starts; and the WLAN client device resumes a non-awake state when the control information indicates the duration satisfies a transition criterion, according to an example embodiment of the invention.

FIG. 3A is an example functional block diagram, illustrating an example WLAN access point device, according to an example embodiment of the invention.

FIG. 3B is an example flow diagram of operational steps in the WLAN access point device of FIG. 3A, wherein the WLAN access point device receives a first message from the WLAN client device, indicating an awake state of the WLAN client device with availability to receive wireless messages from the WLAN access point device; and transmits an acknowledgement message to the WLAN client device, including control information indicating a duration until a service period starts.

FIG. 3C is an example flow diagram of operational steps in the WLAN access point device of FIG. 3A, according to an example embodiment of the invention.

FIG. 4A is an example frame structure of the power save poll packet, according to an example embodiment of the invention.

FIG. 4B is an example frame structure of the acknowledgement message, according to an example embodiment of the invention.

FIG. 5 illustrates an example embodiment of the invention, wherein examples of removable storage media are shown, based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with at least one embodiment of the present invention.

### DISCUSSION OF EXAMPLE EMBODIMENTS OF THE INVENTION

This section is organized into the following topics:

A. WLAN Communication Technology

B. Enhancement to Enable Efficient Power Save

A. WLAN Communication Technology

The IEEE 802.11 standard specifies methods and techniques of an exemplary wireless local area network (WLAN) operation. examples include the IEEE 802.11b and 802.11g wireless local area network specifications, which have been a staple technology for traditional WLAN applications in the 2.4 GHz ISM band. The various amendments to the IEEE 802.11 standard were consolidated for IEEE 802.11a, b, d, e, g, h, i, j protocols, into the base standard IEEE 802.11-2007, Wireless Medium Access Control (MAC) and Physical Layer (PHY) Specifications, June 2007 (incorporated herein by reference). Since then, emerging broadband applications have stimulated interest in developing very high-speed wireless networks for short range communication, for example, the IEEE 802.11n, the planned IEEE 802.11ac, and the planned IEEE 802.11ad WLAN specifications that are to provide a very high throughput in higher frequency bands. Applications of these IEEE 802.11 standards include products such as consumer electronics, telephones, personal computers, and access points for both for home and office.

According to an example embodiment, wireless local area networks (WLANs) typically operate in unlicensed bands. IEEE 802.11b and 802.11g WLANs have been a staple technology for traditional WLAN applications in the 2.4 GHz ISM band and have a nominal range of 100 meters. The IEEE 802.11ah WLAN standard is being developed for operation below 1 GHz and will have a greater range and lower obstruction losses due to its longer wavelength.

According to an example embodiment, an IEEE 802.11 WLAN may be organized as an independent basic service set (IBSS) or an infrastructure basic service set (BSS). The access point (AP) in an infrastructure basic service set (BSS) IEEE 802.11 WLAN network, may be a central hub that relays all communication between the mobile wireless devices (STAs) in an infrastructure BSS. If a STA in an infrastructure BSS wishes to communicate a frame of data to a second STA, the communication may take two hops. First, the originating STA may transfer the frame to the AP. Second, the AP may transfer the frame to the second STA. In an infrastructure BSS, the AP may transmit beacons or respond to probes received from STAs. After a possible authentication of a STA that may be conducted by the AP, an association may occur between the AP and a STA enabling data traffic to be exchanged with the AP. The Access Point (AP) in an Infrastructure BSS may bridge traffic out of the BSS onto a distribution network. STAs that are members of the BSS may exchange packets with the AP.

According to an example embodiment, the IEEE 802.11 WLAN may use two types of transmission: Distributed Coordination Function (DCF) and Point Coordination Function (PCF). DCF employs Carrier Sense Multiple Access with Collision Avoidance (CSMA/CA). A packet sent may be positively acknowledged by the receiver. A transmission may begin with a Request to Send (RTS) and the receiver may respond with a Clear to Send (CTS). The channel may be cleared by these two messages, since all STAs that hear at least one of the CTS and the CTS may suppress their own start of a transmission. The Request to Send (RTS) packet sent by the sender and the Clear to Send (CTS) packet sent in reply by the intended receiver, may alert all other devices within range of the sender or the receiver, to refrain from transmitting for the duration of the main packet.

According to an example embodiment, when data packets are transmitted, each may have a Network Allocation Vector (NAV) containing a duration value to reserve the channel for the sender and receiver for an interval after the current packet, equal to the NAV duration. The network allocation vector (NAV) is an indicator that may be maintained by each STA, of time periods when transmission onto the wireless medium will not be initiated by the STA whether or not the STA's physical carrier sensing function senses that the medium is busy. Use of the NAV for carrier sensing is called virtual carrier sensing. STAs receiving a valid frame may update their NAV with the information received in the duration field for all frames where the new NAV value is greater than the current NAV value, including the RTS and CTS packets, as well data packets. The value of the NAV decrements with the passage of time. Once the sender and receiver have reserved the channel, they may hold it for the remaining duration of the NAV value. The last acknowledgement packet (ACK) contains a NAV value of zero, to release the channel.

According to an example embodiment, standard spacing intervals are defined in the IEEE 802.11 specification, which delay a station's access to the medium, between the end of the last symbol of the previous frame and the beginning of the first symbol of the next frame. The short interframe space (SIFS), the shortest of the interframe spaces, may allow acknowledgement (ACK) frames and clear to send (CTS) frames to have access to the medium before others. The longer duration distributed coordination function (DCF) interframe space (IFS) or DIFS interval may be used for transmitting data frames and management frames.

According to an example embodiment, after the channel has been released, IEEE 802.11 wireless devices normally employ a spectrum sensing capability during the SIFS interval or DIFS interval, to detect whether the channel is busy. A carrier sensing scheme may be used wherein a node wishing to transmit data has to first listen to the channel for a predetermined amount of time to determine whether or not another node is transmitting on the channel within the wireless range. If the channel is sensed to be idle, then the node may be permitted to begin the transmission process. If the channel is sensed to be busy, then the node may delay its transmission for a random period of time called the backoff interval. In the DCF protocol used in IEEE 802.11 networks, the stations, on sensing a channel idle for DIFS interval, may enter the backoff phase with a random value between 0 and CWmin. The backoff counter may be decremented from this selected value as long as the channel is sensed idle.

According to an example embodiment, an algorithm, such as binary exponential backoff, may be used to randomly delay transmissions, in order to avoid collisions. The transmission may be delayed by an amount of time that is the product of the slot time and a pseudo random number. Initially, each sender may randomly wait 0 or 1 slot times. After a busy channel is detected, the senders may randomly wait between from 0 to 3 slot times. After the channel is detected to be busy a second time, the senders may randomly wait between from 0 to 7 slot times, and so forth. As the number of transmission attempts increases, the number of random possibilities for delay increases exponentially. An alternate backoff algorithm is the truncated binary exponential backoff, wherein after a certain number of increases, the transmission timeout reaches a ceiling and thereafter does not increase any further.

According to an example embodiment, it may also be possible to start data transmission directly without RTS-CTS signaling and in that case, the first packet carries information similar to the RTS to start protection.

According to an example embodiment, an IEEE 802.11 WLAN may also be organized as an independent basic service set (IBSS). Wireless devices in an independent basic service set (IBSS) communicate directly with one another and there is no access point in the IBSS. WLAN ad hoc networks have an independent configuration where the mobile devices communicate directly with one another, without support from a fixed access point. WLAN ad hoc networks support distributed activities similar those of the Bluetooth™ piconets. The IEEE 802.11 standard provides wireless devices with service inquiry features similar to the Bluetooth™ inquiry and scanning features.

The independent basic service set (IBSS) has a BSS Identifier (BSSID) that is a unique identifier for the particular ad hoc network. Its format may be identical to that of an IEEE 48-bit address. In an ad hoc network, the BSSID may be a locally administered, individual address that is generated randomly by the device that starts the ad hoc network.

Synchronization is the process of the devices in an ad hoc network getting in step with each other, so that reliable communication is possible. The MAC may provide the synchronization mechanism to allow support of physical layers that make use of frequency hopping or other time-based mechanisms where the parameters of the physical layer change with time. The process may involve beaconing to announce the presence of an ad hoc network, and inquiring to find an ad hoc network. Once an ad hoc network is found, a device may join the ad hoc network. This process may be entirely distributed in ad hoc networks, and may rely on a common timebase provided by a timer synchronization function (TSF). The TSF may maintain a 64-bit timer running at 1 MHz and updated by information from other devices. When a device begins operation, it may reset the timer to zero. The timer may be updated by information received in beacon frames.

Since there is no AP, the mobile device that starts the ad hoc network may begin by resetting its TSF timer to zero and transmitting a beacon, choosing a beacon period. This establishes the basic beaconing process for this ad hoc network. After the ad hoc network has been established, each device in the ad hoc network will attempt to send a beacon after the target beacon transmission time (TGTT) arrives. To minimize actual collisions of the transmitted beacon frames on the medium, each device in the ad hoc network may choose a random delay value which it may allow to expire before it attempts its beacon transmission.

Once a device has performed an inquiry that results in one or more ad hoc network descriptions, the device may choose to join one of the ad hoc networks. The joining process may be a purely local process that occurs entirely internal to the mobile device. There may be no indication to the outside world that a device has joined a particular ad hoc network. Joining an ad hoc network may require that all of the mobile device's MAC and physical parameters be synchronized with the desired ad hoc network. To do this, the device may update its timer with the value of the timer from the ad hoc network description, modified by adding the time elapsed since the description was acquired. This will synchronize the timer to the ad hoc network. The BSSID of the ad hoc network may be adopted, as well as the parameters in the capability information field. Once this process is complete, the mobile device has joined the ad hoc network and is ready to begin communicating with the devices in the ad hoc network.

The access point (AP) in an infrastructure BSS assists those mobile wireless devices (STAs) attempting to save power. The legacy IEEE 802.11e Wireless LAN standards provides for support of low power operation in handheld and battery operated STAs, called automatic power save delivery (APSD). A STA capable of APSD and currently in the power saving mode, will wake up at predetermined beacons received from the AP to listen to a Traffic Indication Map (TIM). If existence of buffered traffic waiting to be sent to the STA is signaled through the TIM, the STA will remain awake until AP sends out all the data. The STA does not need to send a polling signal to the AP to retrieve data, which is the reason for the term “automatic” in the acronym APSD.

Two variations of the APSD feature are unscheduled automatic power save delivery (U-APSD) and scheduled automatic power save delivery (S-APSD). In U-APSD, the access point (AP) is always awake and hence a mobile wireless device (STA) in the power save mode may send a trigger frame or power save poll packet to the AP when the STA wakes up, to retrieve any queued data at the AP and also transmit any data queued from the STA to the AP. In S-APSD, the AP assigns a schedule to a STA and the STA wakes up at the assigned time to retrieve from the AP any data queued for the STA. An AP may maintain multiple schedules either with the same STA or with different STAs in the infrastructure BSS network. Since the AP is never in sleep mode, an AP will maintain different scheduled periods of transmission with different STAs in the infrastructure BSS network to ensure that the STAs get the maximum power savings.

The IEEE 802.11ah WLAN standard operating below 1 GHz, has a greater range and lower obstruction losses due to its longer wavelength. IEEE 802.11ah provides wireless LAN operation in the sub-1 GHz range considered appropriate for sensor networks, machine-to-machine, cellular offload, and smart grid applications. IEEE 802.11ah defines three use case categories:

Use Case 1: Sensors and meters;

Use Case 2: Backhaul sensor and meter data; and

Use Case 3: Extended range Wi-Fi

A principal application of IEEE 802.11ah is sensor networks, for example in smart metering, where the measurement information at each sensor node may be transmitted to an access point. In example sensor applications, the data packet size may be a few hundred bytes, the sensors may have a low duty-cycle, transmitting data every few minutes, and the number of sensor devices may be as large as 6000 devices communicating with an access point.

B. Enhancement to Enable Efficient Power Save

In sensor networks and smart grid applications, large numbers of client wireless devices, both fixed and mobile, will need to communicate with an access point device. In such applications, the client devices operate on battery power and must conserve their power during long periods of inactivity punctuated by short duration communication sessions. In applications where there are a large number of client devices, there is a high likelihood that the wireless medium is loaded and the access point device may not always be able to immediately serve the traffic. When a client wireless device wakes up from a doze or sleep state and attempts to send a power save poll packet to the access point device, it may have to wait to complete its connection due to network overloading, its power will be wasted while it is waiting.

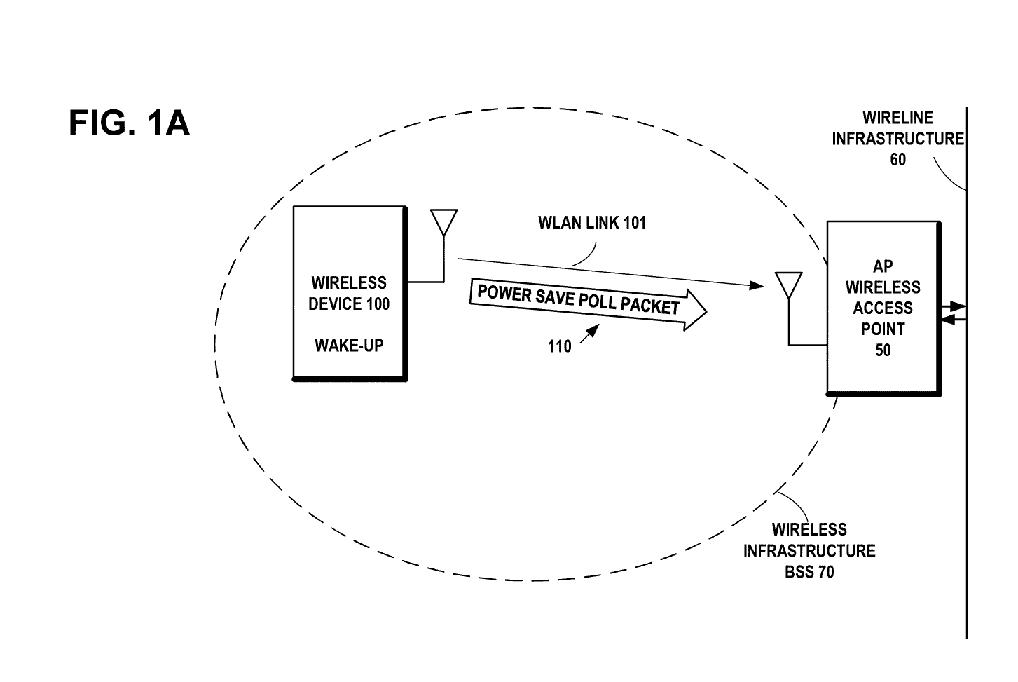

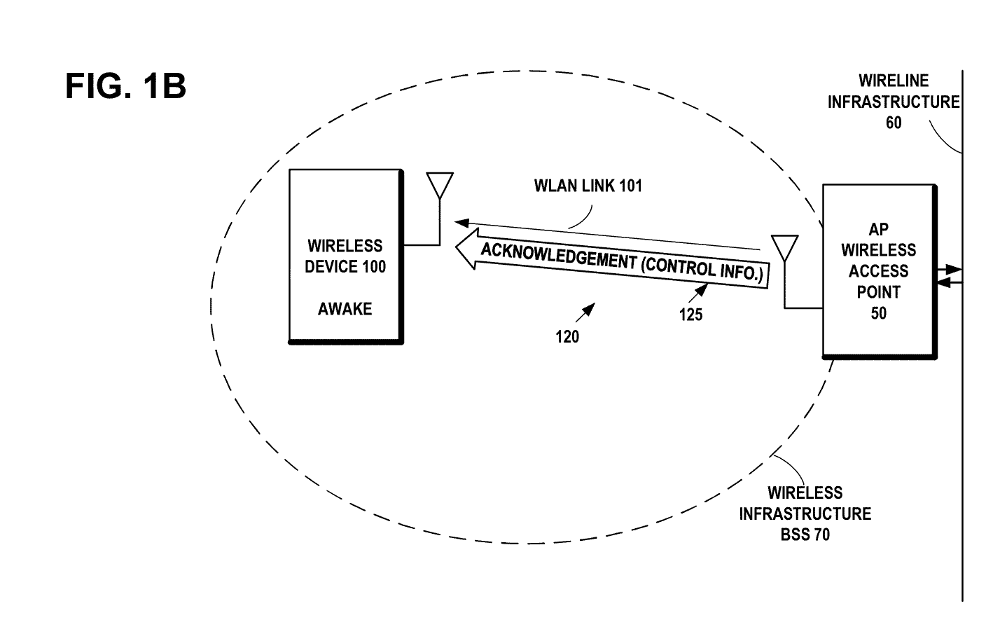

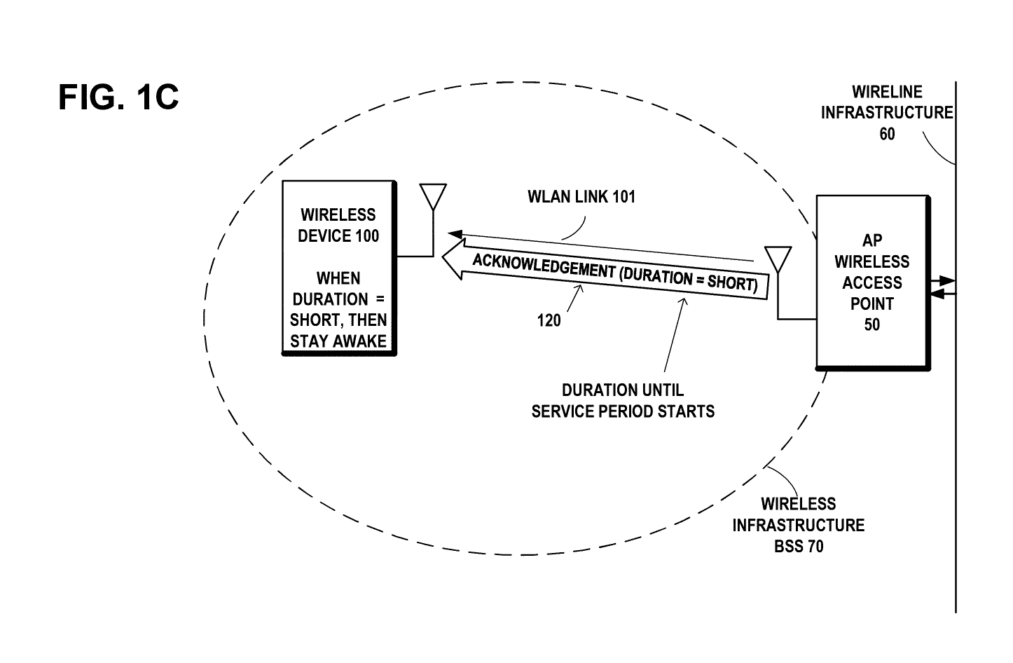

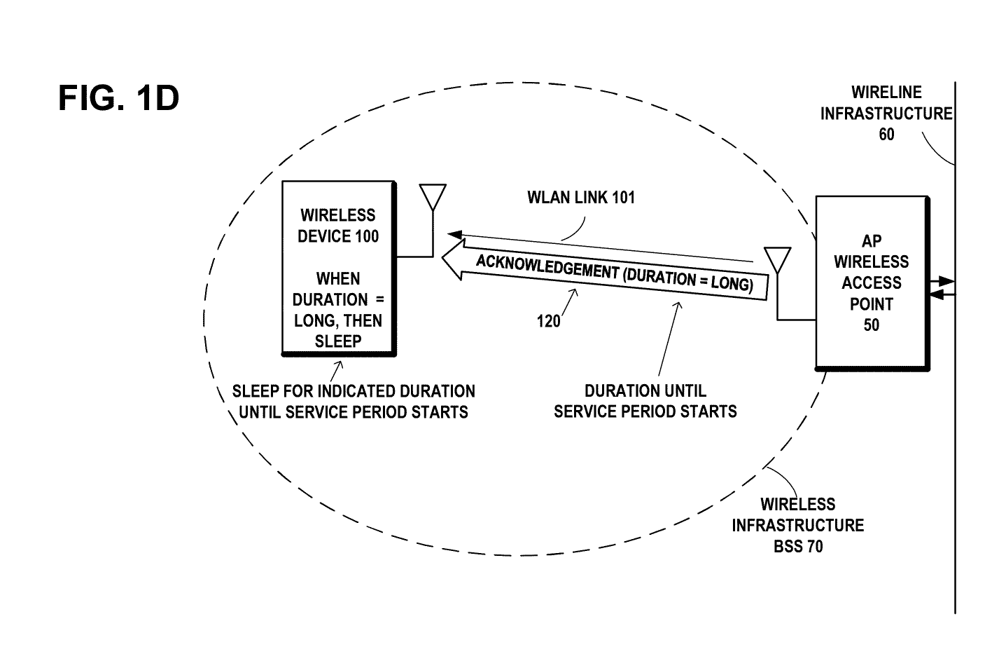

FIG. 1A is an example network diagram of a wireless network, with a WLAN client device 100 that is waking up from a doze or sleep state, sending a power save poll packet 110 to a WLAN access point device 50 over a WLAN link 101 in a wireless infrastructure BSS 70, according to an example embodiment of the invention. The WLAN client device 100 may send the power save poll packet 110 or trigger frame to the WLAN access point device 50 to retrieve any queued data at the WLAN access point device 50 and also transmit any data queued from the WLAN client device 100 to the WLAN access point device 50. The WLAN client device 100 may be a sensor device or a node in a smart grid. Both the WLAN client device 100 and the access point device 50 may be devices operating according to the IEEE 802.11ah communications protocol. The access point device 50 may be connected to a wireline infrastructure 60.

FIG. 1B shows the example network diagram of FIG. 1A, wherein the WLAN access point device 50 transmits an acknowledgement packet 120 to the WLAN client device 100, with control information 125 including a value for a duration until the next service period starts, according to an example embodiment of the invention. The control information 125 in the acknowledgement message 120 may include the duration expressed in at least one of units of time, multiples of beacon durations, or multiples of short beacon durations or fractions of beacon durations. The control information 125 in the acknowledgement message 120 may be in a field used for more-data, the control information 125 indicating either traffic is buffered and a service period starts or indicating no traffic is buffered and the WLAN client device 100 may resume the non-awake state. The control information 125 in the acknowledgement message 120 may include an estimate of a duration of data transmission by the WLAN access point device 50, that needs to be transmitted to the WLAN client device 100 before data buffered in the WLAN client device 100 may be transmitted to the WLAN access point device 50.

FIG. 1C shows the example network diagram of FIG. 1A, wherein the control information 125 in the acknowledgement packet 120 sent to the WLAN client device 100, includes a value for a short duration until the next service period starts and the WLAN client device 100 responds by staying awake, according to an example embodiment of the invention. The WLAN client device 100 remains in the awake state when the control information 125 indicates that there is data buffered for the WLAN client device 100 in the WLAN access point device 50.

FIG. 1D shows the example network diagram of FIG. 1A, wherein the control information 125 in the acknowledgement packet 120 sent to the WLAN client device 100, includes a value for a long duration until the next service period starts and the WLAN client device 100 responds by going back to sleep for the indicated duration until the service period starts, according to an example embodiment of the invention. The WLAN client device 100 may resume the awake state when the duration has expired.

In an example embodiment of the invention, the control information 125 may indicate that there are no buffered data packets for the WLAN client device 100, in the WLAN access point device 50, because an estimated duration for the WLAN access point device 50 to send data to the WLAN client device 100 is greater than a long duration value due to network overload.

In an example embodiment of the invention, the WLAN client device 100 transmits to WLAN access point device 50, a first message 110, such as a power save poll packet, indicating an awake state with availability to receive wireless messages from the WLAN access point device 50. The WLAN client device 100 receives an acknowledgement message 120 from the WLAN access point device, including control information 125 indicating a duration until a service period starts. The WLAN client device 100 may resume a non-awake state when the control information 125 indicates the duration satisfies a transition criterion.

In an example embodiment of the invention, the transition criterion may include a determination of the duration required for the WLAN client device 100 to switch from the awake state back to the doze or sleep state. If the switching duration is longer than the duration until a service period starts, then the WLAN client device 100 cannot enter and return from the doze or sleep state before the service period starts. In such case, the transition criterion is not satisfied and the WLAN client device 100 will remain in the awake state. Typically, a switching transition in current technologies may take about 1 millisecond, however the stitching transition may be much faster in the future technologies.

In an example embodiment of the invention, the transition criterion may also include a determination of the energy consumption of the WLAN client device 100 in various states. For example, the transition criterion may also depend on a comparison of energy consumption of WLAN client device 100 in the awake state to energy consumption of transitions to and from the doze or sleep state, and to energy consumption in the doze or sleep state. If the energy consumption of WLAN client device 100 when switching to the doze or sleep state, is lower than it would be by remaining in the awake state, then the device should transition to the doze or sleep state, as long as the switching duration is not longer than the duration until a service period starts.

In an example embodiment of the invention, the transition criterion may also include a random value component. In an example embodiment of the invention, the transition criterion may also be dependent on the operational state of the WLAN client device 100.

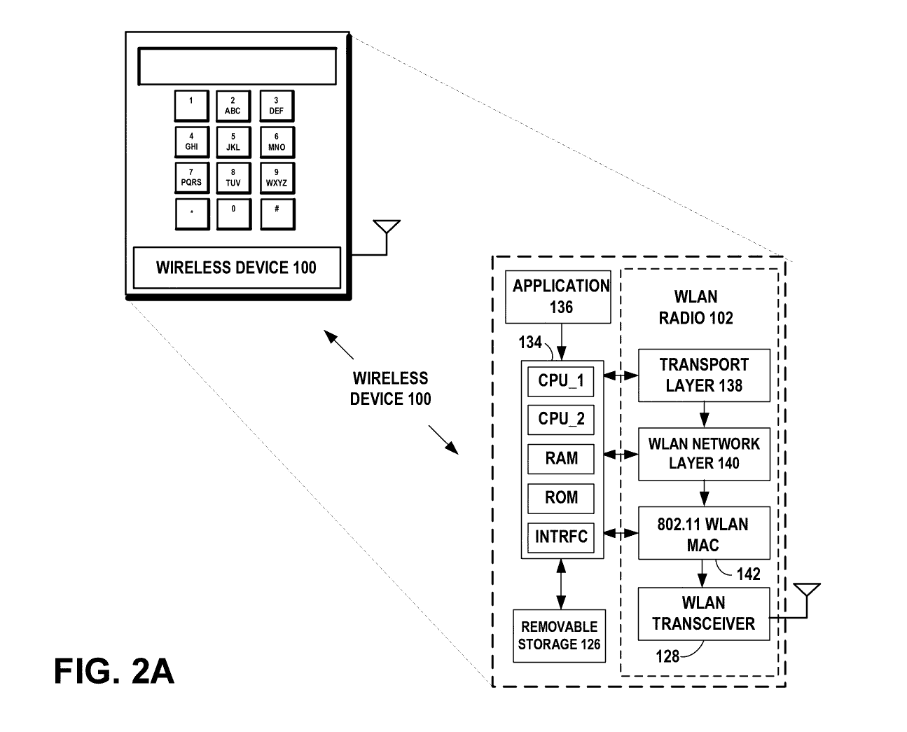

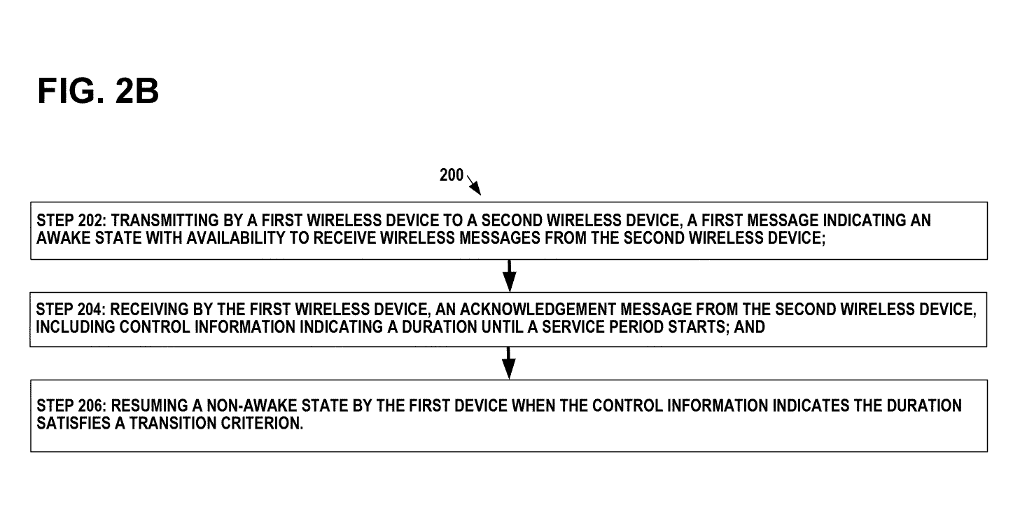

FIG. 2A is an example functional block diagram, illustrating an example WLAN client device 100, according to an example embodiment of the invention. The example WLAN client device 100 may include a processor 134 that may include a dual or multi-core central processing unit CPU_1 and CPU_2, a RAM memory, a ROM memory, and an interface for a keypad, display, and other input/output devices. The example WLAN client device 100 may include a protocol stack, including the transceiver 128 and IEEE 802.11 MAC 142, which may be based, for example, on the IEEE 802.11ah WLAN standard. The protocol stack may also include a network layer 140, a transport layer 138, and an application program 136.

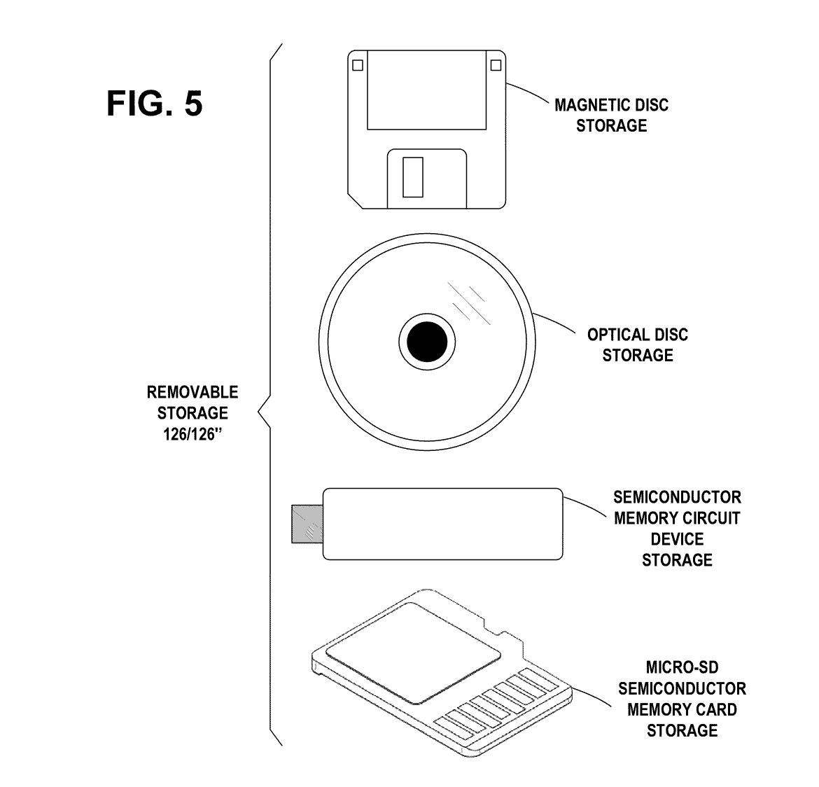

In an example embodiment, the interface circuits in FIG. 2A may interface with one or more radio transceivers, battery and other power sources, key pad, touch screen, display, microphone, speakers, ear pieces, camera or other imaging devices, etc. The RAM and ROM may be removable memory devices such as smart cards, SIMs, WIMs, semiconductor memories such as RAM, ROM, PROMS, flash memory devices, etc. The processor protocol stack layers, and/or application program may be embodied as program logic stored in the RAM and/or ROM in the form of sequences of programmed instructions which, when executed in the CPU, carry out the functions of example embodiments. The program logic may be delivered to the writeable RAM, PROMS, flash memory devices, etc. from a computer program product or article of manufacture in the form of computer-usable media such as resident memory devices, smart cards or other removable memory devices. Alternately, they may be embodied as integrated circuit logic in the form of programmed logic arrays or custom designed application specific integrated circuits (ASIC). The one or more radios in the device may be separate transceiver circuits or alternately, the one or more radios may be a single RF module capable of handling one or multiple channels in a high speed, time and frequency multiplexed manner in response to the processor. An example of removable storage media 126, as shown in FIG. 5, may be based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with at least one embodiment of the present invention.

FIG. 2B is an example flow diagram of operational steps in the WLAN client device 100 of FIG. 2A, wherein the WLAN client device 100 transmits to WLAN access point device 50, a first message 110 indicating an awake state with availability to receive wireless messages from the WLAN access point device 50; the WLAN client device 100 receives an acknowledgement message 120 from the WLAN access point device, including control information 125 indicating a duration until a service period starts; and the WLAN client device 100 resumes a non-awake state when the control information 125 indicates the duration satisfies a transition criterion, according to an example embodiment of the invention.

The steps of the flow diagram 200 of FIG. 2B may represent computer code instructions stored in the RAM and/or ROM memory of the WLAN client device 100, which when executed by the central processing units (CPU), carry out the functions of an example embodiment of the invention. The steps may be carried out in another order than shown and individual steps may be combined or separated into component steps.

Step 202: transmitting by a first wireless device to a second wireless device, a first message indicating an awake state with availability to receive wireless messages from the second wireless device;

Step 204: receiving by the first wireless device, an acknowledgement message from the second wireless device, including control information indicating a duration until a service period starts; and

Step 206: resuming a non-awake state by the first device when the control information indicates the duration satisfies a transition criterion.

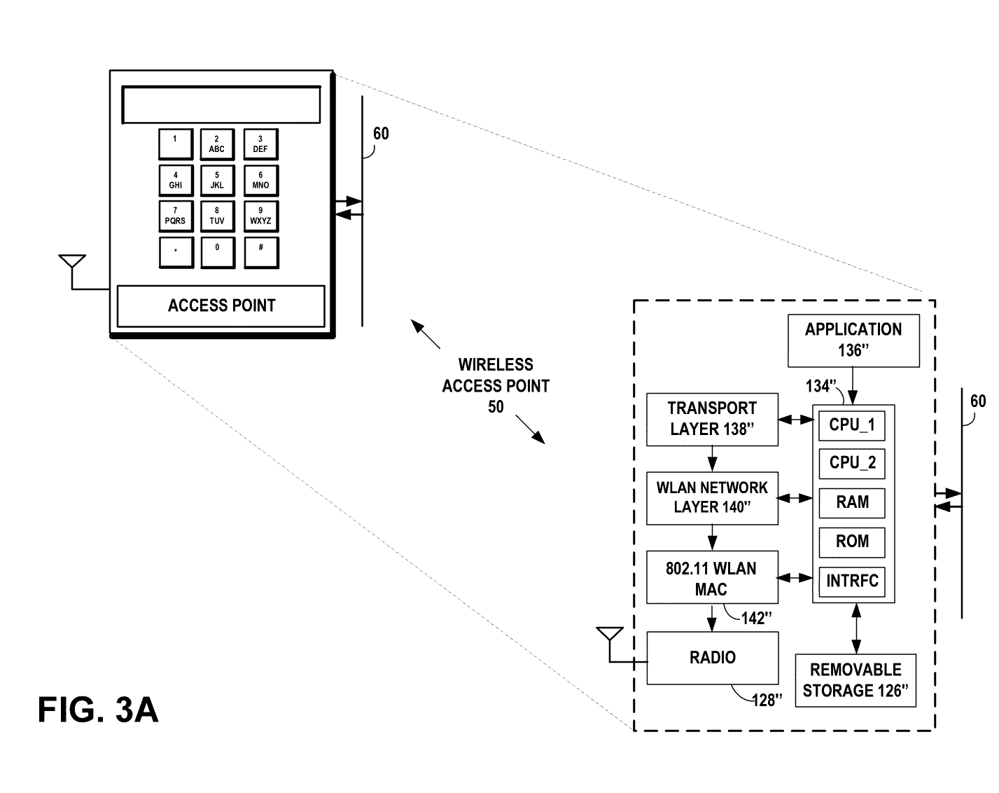

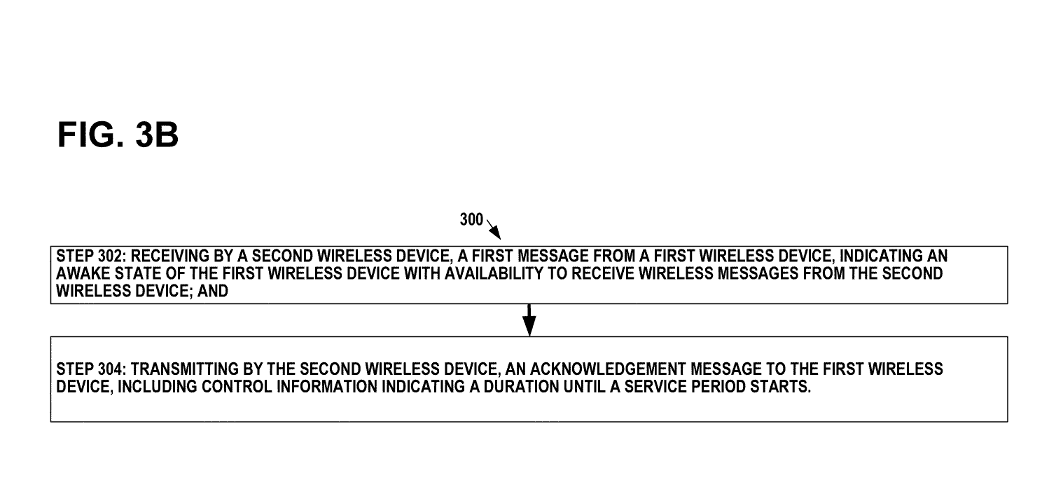

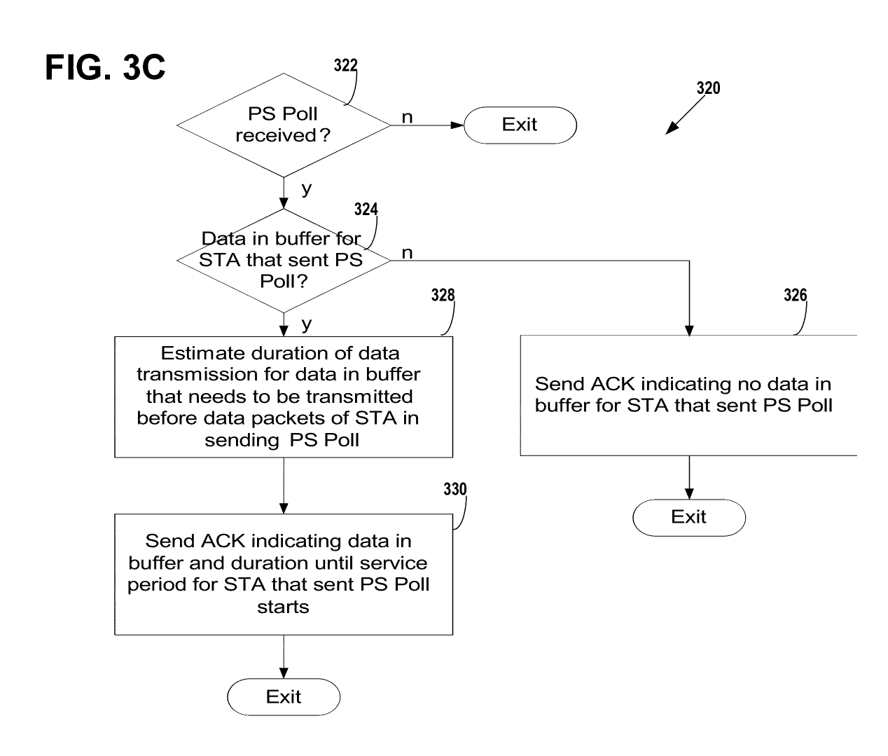

FIG. 3A is an example functional block diagram, illustrating an example WLAN access point device 50, according to an example embodiment of the invention. The example WLAN access point device 50 may include a processor 134″ that may include a dual or multi-core central processing unit CPU_1 and CPU_2, a RAM memory, a ROM memory, and an interface for a keypad, display, and other input/output devices. The example WLAN access point device 50 may include a protocol stack, including the transceiver 128″ and IEEE 802.11ah MAC 142″, which may be based, for example, on the IEEE 802.11ah WLAN standard. The protocol stack may also include a network layer 140″, a transport layer 138″, and an application program 136″.

In an example embodiment, the interface circuits in FIG. 3A may interface with one or more radio transceivers, battery and other power sources, key pad, touch screen, display, microphone, speakers, ear pieces, camera or other imaging devices, etc. The RAM and ROM may be removable memory devices such as smart cards, SIMs, WIMs, semiconductor memories such as RAM, ROM, PROMS, flash memory devices, etc. The processor protocol stack layers, and/or application program may be embodied as program logic stored in the RAM and/or ROM in the form of sequences of programmed instructions which, when executed in the CPU, carry out the functions of example embodiments. The program logic may be delivered to the writeable RAM, PROMS, flash memory devices, etc. from a computer program product or article of manufacture in the form of computer-usable media such as resident memory devices, smart cards or other removable memory devices. Alternately, they may be embodied as integrated circuit logic in the form of programmed logic arrays or custom designed application specific integrated circuits (ASIC). The one or more radios in the device may be separate transceiver circuits or alternately, the one or more radios may be a single RF module capable of handling one or multiple channels in a high speed, time and frequency multiplexed manner in response to the processor. An example of removable storage media 126″, as shown in FIG. 5, may be based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with at least one embodiment of the present invention.

FIG. 3B is an example flow diagram of operational steps in the WLAN access point device of FIG. 3A, wherein the WLAN access point device receives a first message 110 from the WLAN client device 100, indicating an awake state of the WLAN client device 100 with availability to receive wireless messages from the WLAN access point device 50; and transmits an acknowledgement message 120 to the WLAN client device 100, including control information 125 indicating a duration until a service period starts, according to an example embodiment of the invention.

The steps of the flow diagram 300 of FIG. 3B may represent computer code instructions stored in the RAM and/or ROM memory, which when executed by the central processing units (CPU), carry out the functions of an example embodiment of the invention. The steps may be carried out in another order than shown and individual steps may be combined or separated into component steps.

Step 302: receiving by a second wireless device, a first message from a first wireless device, indicating an awake state of the first wireless device with availability to receive wireless messages from the second wireless device; and

Step 304: transmitting by the second wireless device, an acknowledgement message to the first wireless device, including control information indicating a duration until a service period starts.

FIG. 3C is an example flow diagram 320 of operational steps in the WLAN access point device 50 of FIG. 3A, according to an example embodiment of the invention. The steps of the flow diagram 300 of FIG. 3C may represent computer code instructions stored in the RAM and/or ROM memory, which when executed by the central processing units (CPU), carry out the functions of an example embodiment of the invention. The steps may be carried out in another order than shown and individual steps may be combined or separated into component steps.

Step 322: Power save poll received?

Step 324: Data in buffer for WLAN client device 100 (STA) that sent Power save poll?

Step 326: No, Send acknowledgement message (ACK) indicating no data in buffer for STA that sent Power save poll

Step 328: Yes, Estimate duration of data transmission for data in buffer that needs to be transmitted before data packets of STA in sending Power save poll

Step 330: Send ACK indicating data in buffer and duration until service period for STA that sent Power save poll.

A value may be reserved representing a duration value greater than a maximum value. The client device receiving the ACK will then know that there is data buffered in the access point device, but that cannot be delivered at the moment. The client device may then wake up at a random point in time after the maximum duration. The maximum duration may be defined in a communications standard or it may be explicitly signaled.

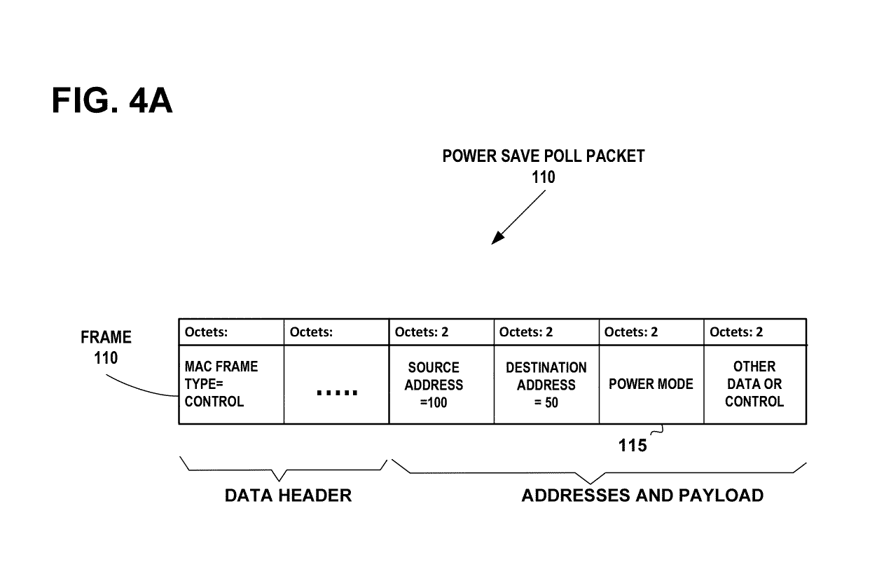

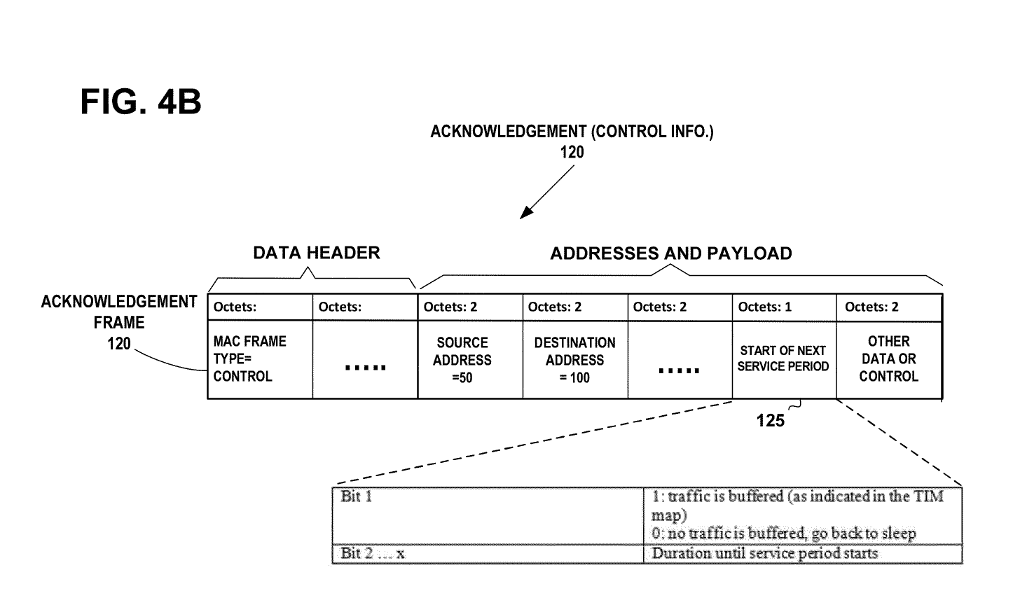

FIG. 4A is an example frame structure of the power save poll packet 110, according to an example embodiment of the invention. An example frame structure is shown of an IEEE 802.11ah packet frame 110 transmitted from the WLAN client device 100 to the WLAN access point 50, according to an example embodiment of the invention. The payload portion of the packet frame 110 may include a power mode field 115.

FIG. 4B is an example frame structure of the acknowledgement message 120, according to an example embodiment of the invention. An example frame structure is shown of an IEEE 802.11ah modified packet frame 120 transmitted from the WLAN access point 50 to the WLAN client device 100, containing the control information 125 indicating a duration until a service period starts. The control information 125 in the acknowledgement message 120 may include the duration expressed in at least one of units of time, multiples of beacon durations, or multiples of short beacon durations or fractions of beacon durations. The control information 125 in the acknowledgement message 120 may be in a field used for more-data, the control information 125 indicating either traffic is buffered and a service period starts or indicating no traffic is buffered and the WLAN client device 100 may resume the non-awake state. The control information 125 in the acknowledgement message 120 may include an estimate of a duration of data transmission by the WLAN access point device 50, that needs to be transmitted to the WLAN client device 100 before data buffered in the WLAN client device 100 may be transmitted to the WLAN access point device 50.

FIG. 5 illustrates an example embodiment of the invention, wherein examples of removable storage media 126 and 126″ are shown, based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with at least one embodiment of the present invention.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable non-transitory medium.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless communication networks, the Internet, intranets, telephone/modem-based network communication, hard-wired/cabled communication network, satellite communication, and other stationary or mobile network systems/communication links.

Although specific example embodiments of the invention have been disclosed, a person skilled in the art will understand that changes can be made to the specific example embodiments without departing from the spirit and scope of the invention.

What is claimed is:

1. A method, comprising:
transmitting by a first wireless device to a second wireless device, a first message indicating an awake state with availability to receive wireless messages from the second wireless device;
receiving by the first wireless device, an acknowledgement message from the second wireless device, including control information indicating a duration until a service period starts; and
resuming a non-awake state by the first device when the control information indicates the duration satisfies a transition criterion.

2. The method of claim 1, further comprising:
resuming the awake state by the first device when the duration has expired.

3. The method of claim 1, further comprising:
remaining in the awake state by the first device when the control information indicates that the duration until the service period starts is less than a first value.

4. The method of claim 1, further comprising:
wherein the first message is a power save poll packet indicating an awake state with availability to receive wireless messages from the second wireless device

5. The method of claim 1, further comprising:
wherein the control information in the acknowledgement message is in a field for more-data, the control information indicating either traffic is buffered and a service period starts or indicating no traffic is buffered and the first wireless device may resume the non-awake state.

6. The method of claim 1, further comprising:
wherein the control information in the acknowledgement message includes the duration expressed in at least one of units of time, multiples of beacon durations, or multiples of short beacon durations or fractions of beacon durations.

7. The method of claim 1, further comprising:
wherein the control information in the acknowledgement message includes an estimate of a duration of data transmission by the second wireless device, that needs to be transmitted to the first wireless device before data buffered in the first wireless device may be transmitted to the second wireless device.

8. An apparatus, comprising:
at least one processor;
at least one memory including computer program code;
the at least one memory and the computer program code configured to, with the at least one processor, cause the apparatus at least to:
transmit to a second wireless device, a first message indicating an awake state with availability to receive wireless messages from the second wireless device;
receive an acknowledgement message from the second wireless device, including control information indicating a duration until a service period starts; and
resume a non-awake state when the control information indicates the duration satisfies a transition criterion.

9. The apparatus of claim 8, further comprising:
the at least one memory and the computer program code configured to, with the at least one processor, cause the apparatus at least to:
resume the awake state when the duration has expired.

10. The apparatus of claim 8, further comprising:
the at least one memory and the computer program code configured to, with the at least one processor, cause the apparatus at least to:
remain in the awake state by the first device when the control information indicates that the duration until the service period starts is less than a first value.

11. The apparatus of claim 8, further comprising:
the at least one memory and the computer program code configured to, with the at least one processor, cause the apparatus at least to:
remain in the awake state when the control information indicates that there is data buffered for the apparatus in the second device.

12. A computer program product comprising computer executable program code recorded on a computer readable, non-transitory storage medium, the computer executable program code comprising:
code for transmitting to a second wireless device, a first message indicating an awake state with availability to receive wireless messages from the second wireless device;
code for receiving an acknowledgement message from the second wireless device, including control information indicating a duration until a service period starts; and
code for resuming a non-awake state when the control information indicates the duration satisfies a transition criterion.

13. A method, comprising:
receiving by a second wireless device, a first message from a first wireless device, indicating an awake state of the first wireless device with availability to receive wireless messages from the second wireless device; and
transmitting by the second wireless device, an acknowledgement message to the first wireless device, including control information indicating a duration until a service period starts.

14. The method of claim 13, further comprising:
wherein the control information indicates that there is data buffered for the first device in the second wireless device.

15. The method of claim 13, further comprising:
indicating by the second wireless device in the control information, that there are no buffered data packets for the first wireless device, in the second wireless device, when an estimated duration for the second wireless device to send data to the first wireless device is greater than a duration value due to network overload.

16. The method of claim 13, further comprising:
estimating by the second wireless device a duration for the second wireless device to send data to the first wireless device is greater than a duration value, due to network overload; and
transmitting by the second device to the first device, the acknowledgement message indicating that there are no buffered data packets for the first wireless device buffered in the second wireless device.

17. The method of claim 13, further comprising:
creating by the second wireless device the control information in the acknowledgement message in a field for more-data, the control information indicating either traffic is buffered and a service period starts or indicating no traffic is buffered and the first wireless device may resume the non-awake state.

18. The method of claim 13, further comprising:
estimating a duration of data transmission by the second wireless device, that needs to be transmitted to the first wireless device before data buffered in the first wireless device may be transmitted to the second wireless device; and
transmitting the estimated duration in the control information in the acknowledgement message.

19. An apparatus, comprising:
at least one processor;
at least one memory including computer program code;
the at least one memory and the computer program code configured to, with the at least one processor, cause the apparatus at least to:
receive a first message from a first wireless device, indicating an awake state of the first wireless device with availability to receive wireless messages from the apparatus; and
transmit an acknowledgement message to the first wireless device, including control information indicating a duration until a service period starts.

20. The apparatus of claim 19, further comprising:
the at least one memory and the computer program code configured to, with the at least one processor, cause the apparatus at least to:
indicate in the control information, that there are no buffered data packets for the first wireless device, in the apparatus, when an estimated duration for the apparatus to send data to the first wireless device is greater than a duration value due to network overload.

21. The apparatus of claim 19, further comprising:
the at least one memory and the computer program code configured to, with the at least one processor, cause the apparatus at least to:
estimate a duration to send data to the first wireless device is greater than a duration value, due to network overload; and
transmit to the first device, the acknowledgement message indicating that there are no buffered data packets for the first wireless device buffered in the apparatus.

22. The apparatus of claim 19, further comprising:
the at least one memory and the computer program code configured to, with the at least one processor, cause the apparatus at least to:
create the control information in the acknowledgement message in a field for more-data, the control information indicating either traffic is buffered and a service period starts or indicating no traffic is buffered and the first wireless device may resume the non-awake state.

23. The apparatus of claim 19, further comprising:
the at least one memory and the computer program code configured to, with the at least one processor, cause the apparatus at least to:
estimate a duration of data transmission that needs to be transmitted to the first wireless device before data buffered in the first wireless device may be transmitted to the apparatus; and
transmit the estimated duration in the control information in the acknowledgement message.

24. A computer program product comprising computer executable program code recorded on a computer readable, non-transitory storage medium, the computer executable program code comprising:
code for receiving a first message from a first wireless device indicating an awake state of the first wireless device with availability to receive wireless messages; and
code for transmitting an acknowledgement message to the first wireless device, including control information indicating a duration until a service period starts.
